(19) United States
(12) Patent Application Publication
(10) Pub. No.: US 2008/0008873 A1
(43) Pub. Date: Jan. 10, 2008

(54) Water-soluble substrate with resistance to dissolution prior to being immersed in water

(75) Inventor: Vincenzo Catalfamo, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/824,632

(22) Filed: Jul. 2, 2007

Related U.S. Application Data
(60) Provisional application No. 60/818,691, filed on Jul. 5, 2006.

(51) Int. Cl. B32B 17/00; B05D 1/04

(52) U.S. Cl. 428/325; 427/180; 427/475

(57) ABSTRACT

A water-soluble substrate, and more particularly a water-soluble substrate that is resistant to contact with small amounts of water, and methods of making the same are disclosed. The water-soluble substrate comprises a first surface and a second surface, and has glass beads applied to at least one of said first and second surfaces, said glass beads having an average diameter of from 1 micrometer to 5000 micrometers. Articles, such as pouches, made from the water-soluble substrate, are also disclosed herein.

### CROSS REFERENCE TO RELATED APPLICATION

This application claims the benefit of U.S. Provisional Application Ser. No. 60/818,691, filed Jul. 5, 2006, the disclosure of which is incorporated by reference.

### FIELD OF THE INVENTION

This invention relates to a water-soluble substrate, and more particularly a water-soluble substrate which has improved resistance to dissolution prior to being immersed in water, and methods of making the same. This invention also relates to articles, such as pouches, made from the water-soluble substrate.

### BACKGROUND OF THE INVENTION

Water-soluble substrates are gaining wider acceptance for use as packaging materials. Packaging materials include films, sheets, blown or molded hollow bodies (i.e. sachets, pouches, and tablets), bottles, receptacles and the like. Often, water-soluble substrates, when used in the preparation of certain types of these articles such as sachets and pouches, disintegrate and/or become sticky when exposed to small amounts of water or high humidity. This can make them unsuitable for usage in the packaging and storage of the compositions contained therein.

The most common consumer complaint for water-soluble pouches is linked to unwanted pouch dissolution when accidentally exposed to small amounts of water, such as when water gets inside the outer packaging in which the pouches are sold and stored after purchase, from wet hands, high humidity, leaking sinks, or pipes during storage. This may cause the water-soluble pouches to leak prior to use and/or stick together. The second most frequent complaint is that of the water-soluble pouch failing to fully dissolve upon use. Thus, there remains an unmet need for water-soluble substrates and articles made therefrom, such as sachets and pouches, which has improved resistance to dissolution against exposure to small amounts of water yet can dissolve very quickly when immersed in an aqueous solution, such as rinse and/or wash water.

Various methods are known in the art to make water-soluble substrates more resistant to dissolution to overcome the above mentioned problems. Typically, one or both sides of the water-soluble substrate are coated. For example, U.S. Pat. No. 6,509,072 describes a water-soluble substrate comprising a barrier coating. The barrier coating is a polymeric film which forms a continuous film on the water-soluble substrate. Another example of a barrier coating is described in WO 01/23460, assigned to Kao Corporation, wherein a surface of the water-soluble substrate is coated with a particulate or fibrous water-insoluble material

Although barrier coatings of the prior art provide water-soluble substrates with some resistance to dissolution, there is still a need to further improve the dissolution properties of the coated substrates. Another problem with barrier coatings is, however, that the aesthetics of the water-soluble substrate may be negatively impacted. Generally, such coatings are colourless and have a mat appearance. Articles, such as pouches, made of such water-soluble substrates thus have inferior aesthetics and/or make it difficult for users to inspect the contents of such articles.

It is therefore an aspect of the present invention to provide water-soluble substrates which have improved resistance to solubility prior to being immersed in water, yet are aesthetically appealing and/or allow inspection of the contents of articles made from said water-soluble substrate.

### SUMMARY OF THE INVENTION

The present invention relates to a water-soluble substrate comprising a first surface and a second surface opposite to said first surface, having glass beads applied to at least one of said first and second surfaces, said glass beads having an average diameter of from 1 micrometer to 5000 micrometers.

The present invention also relates to an articles comprising the water-soluble substrate, and to a method of making the water-soluble substrate.

### BRIEF DESCRIPTION OF THE DRAWINGS

FIG. 1 shows a cross-section of a non-coated water-soluble substrate.

FIG. 2 shows a cross-section of one embodiment of a water-soluble substrate according to the present invention.

FIG. 3 shows a cross-section of another embodiment of a water-soluble substrate according to the present invention.

FIG. 4 shows a cross-section of another embodiment of a water-soluble substrate according to the present invention.

FIG. 5 shows a cross-section of another embodiment of a water-soluble substrate according to the present invention.

FIG. 6 shows a cross-section of an article comprising a water-soluble substrate according to the present invention.

### DETAILED DESCRIPTION OF THE INVENTION

This invention relates to a water-soluble substrate, and more particularly a water-soluble substrate which has improved resistance to dissolution prior to being immersed in water, and methods of making the same. This invention also relates to articles comprising the water-soluble substrate described herein.

### Water-Soluble Substrate

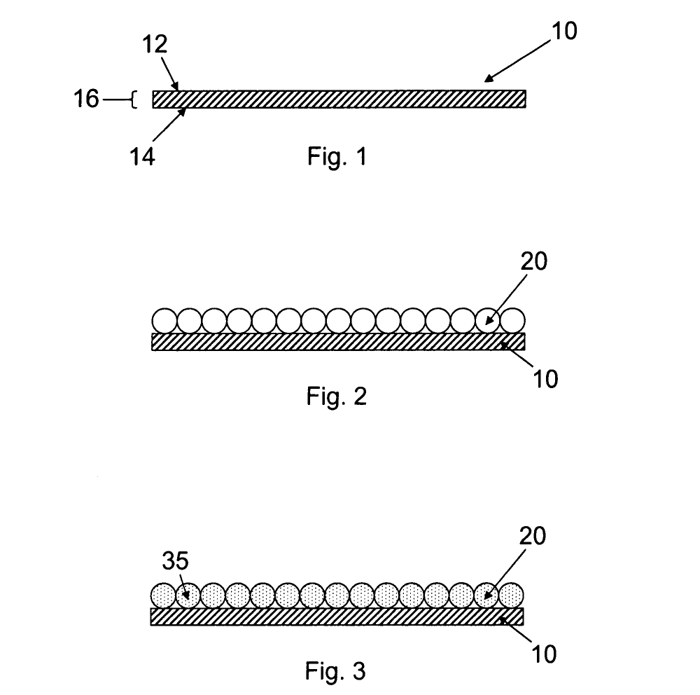

FIG. 1 shows a cross-section of a water-soluble substrate 10. The water-soluble substrate 10 has a first surface 12, and a second surface 14 opposite to the first surface 12. The thickness 16 of the water-soluble substrate 10 between the first surface 12 and the second surface 14 can range from about 0.75 micrometer to about 1,250 micrometer, preferably from about 10 micrometer to about 250 micrometer, more preferably from about 25 micrometer to about 125 micrometer. The water-soluble substrate 10 can be in the form of a film, a sheet, or a foam, and includes woven and nonwoven structures.

The water-soluble substrate is made of polymeric materials and has a water-solubility of at least 50 weight %, as measured by the method set out here after using a glass-filter with a maximum pore size of 20 microns. Preferably, the water-solubility of the substrate is at least 75 weight % or even more preferably at least 95 weight %.

50 grams±0.1 gram of substrate material is added in a pre-weighed 400 ml beaker and 245 ml±1 ml of 25° C. distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved fraction). Then, the % solubility can be calculated.

Typically the water-soluble substrate 10 has a basis weight of from 0.33 to 1,667 grams per square meter, preferably from 33 to 167 grams per square meter. The thickness of the water-soluble substrate 10 between the first surface 12 and the second surface 14 can range from about 0.75 micrometer to about 1,250 micrometer, preferably from about 10 micrometer to about 250 micrometer, more preferably from about 25 micrometer to about 125 micrometer.

Preferred polymers, copolymers or derivatives thereof suitable for use as substrate material are selected from polyvinyl alcohol (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohol copolymers, hydroxypropyl methyl cellulose (HPMC), and mixtures thereof. The most preferred polymer is polyvinyl alcohol. Preferably, the level of polymer in the substrate is at least 60%.

An example of commercially available water-soluble films are PVA films known under the trade reference Monosol M8630, as sold by Chris-Craft Industrial Products of Gary, Ind., US, and PVA films of corresponding solubility and deformability characteristics. Other films suitable for use herein include films known under the trade reference PT film or the K-series of films supplied by Aicello, or VF-HP film supplied by Kuraray.

### Glass Beads

As shown in FIG. 2, glass beads 20 are applied to at least one of the first or second surfaces 12, 14 of the water-soluble substrate 10. Preferably, at least 5%, more preferably at least 15%, and most preferably at least 50% and up to 100% of the first and/or second surface 12, 14 are covered by the glass beads 20. This ensures that upon accidental water-contact, the water will either not be able to reach the first or second surface 12, 14 of the water-soluble substrate 10, or the amount of water that reaches said surface, is not enough to completely solubilise the water-soluble substrate 10.

The glass beads 20 have an average diameter of from 1 to 5,000 micrometers, preferably from 1 to 100 micrometers, even more preferably from 5 to 50 micrometers.

In one preferred embodiment, the glass beads 20 are hollow. This provides the advantage that the coating is of a low weight. Especially glass beads having a diameter in the lower ranges, would not have a great impact on the overall weight of the coated water-soluble substrate, nor on the overall weight of articles made from the coated water-soluble substrate. Another advantage of using hollow glass beads 20 is provided when articles comprising water-soluble substrates 10 coated with hollow glass beads 20, are to be used in applications involving mechanical agitation such as in washing machines. Due to the mechanical agitation, and contact of the coating with other articles (such as garments) or parts of the device (e.g. inside wall of the drum), they easily break. As a result, the coated water-soluble substrate becomes water-soluble at the required moment and the broken pieces of the glass beads 20, due to their small size, do not pose any problems with respect to safety or disposal, as they will simply be drained out together with the wash water.

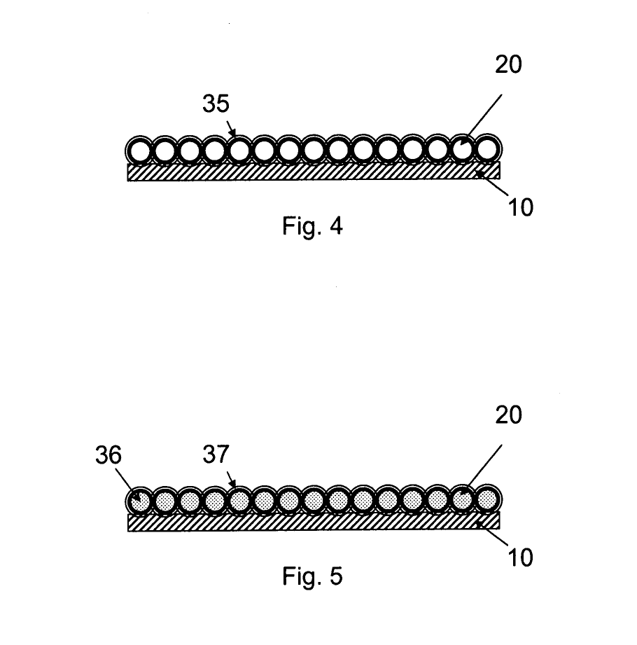

In another preferred embodiment, glass beads 20 can be used to deliver benefit agents. As shown in FIG. 3, a composition 35 comprising one or more benefit agents can be incorporated inside hollow glass beads 20. Alternatively, as shown in FIG. 4, the outside surface of the glass beads 20 (irrespective of whether the glass beads are hollow or not) may be coated with a composition 35 comprising one or more benefit agents. This allows to maximize the exposed coated surface area with the given composition, hence to increase the coated area with the composition in relation to the surface of the film. Another alternative, as shown in FIG. 5, is to provide hollow glass beads 20 which have a first composition 36 incorporated inside the glass beads, and a second composition 37 applied to the outside surface of the glass beads 20, wherein the first and second composition 36, 37 can be different or equal. The water-soluble substrate 10 may also be coated with a mixture of several types of glass beads 20 each type comprising a different composition on the inside, outside or both. As such, it is possible to deliver benefit agents via articles such as pouches, which are not compatible with the product or composition inside the article. Examples of benefit agents which can be incorporated inside the hollow glass beads, or applied to the outside surface of glass beads include, but are not limited thereto, cleaning agents, soil suspending agents, anti-redeposition agents, optical brighteners, bleaches, enzymes, perfume compositions, bleach activators and precursors, shining agents, suds suppressor agents, fabric caring compositions, surface nurturing compositions.

Another advantage of glass beads 20 is that they can provide improved aesthetics to the water-soluble substrate, already due to the transparent nature thereof.

In one preferred embodiment, the glass beads 20 can be colored. The water-soluble substrate 10 can be coated with glass beads 20 having one and the same color, or with a mixture of glass beads 20 having different colors. As such, visually appealing effects, such as graphics, cartoons, logo's, branding, user's instructions, and the like can be created. Alternatively, hollow glass beads 20 can be filled with a colored composition, said composition optionally comprising one or more benefit agents as described above.

In another preferred embodiment, the outer surface of the glass beads 20 may be partially, or substantially entirely coated with silicone. The hydrophobic properties of the silicone further increases the water-repellency of the coating, and thus increases the resistance of the coated water-soluble substrate 10 against accidental water-contact.

In yet another preferred embodiment, the outer surface of the glass beads 20 may be partially, or substantially entirely coated with silver and/or silver compounds or any other suitable material such as titanium, tin, aluminum and their compounds which reflects and/or diffracts light. Also it can be coated with fluorescent and photo-luminescent coatings and pigments.

The water-soluble substrate 10 may be coated with a combination of any of the above described embodiments of the glass beads 20.

Examples of suitable glass beads 20 are available from Sovitec (multiple locations in Europe and South America), under the trade name Microbeads, Vialux, Echolux and others. Glass beads are also available from Jinan Huaming Microbead Co., Ltd (Jinan, China), such as the glass beads with refractive index 1.93 and 2.2, photo-luminescent and colored Glass beads and E-bead™. Also, hollow glass beads materials are available from Naewoikorea (Seoul, South Korea) under the trade name Hique™ and from Potters Industries Inc. (Valley Forge, Pa.), under the trade name Spheriglass™ (solid glass micro beads) and Sphericel™ (hollow glass micro beads).

### Optional Ingredients

It may be required for certain applications that the dissolution rate (when immersed) of the substrate is increased. Disintegrants may be applied on the surface of the water-soluble substrate 10 opposite to the surface onto which the glass beads 20 are applied, or they may be applied onto both surfaces of the water-soluble substrate 10, or they may be integrated into the water-soluble film 10, or any combination thereof. Preferably, the level of disintegrant is from 0.1 to 30% preferably from 1 to 15% by weight of said substrate. Suitable disintegrants for use herein are corn/potato starch, methyl cellulose/celluloses, mineral clay powders, croscarmelose (cross-linked cellulose), crospovidine (cross-linked polymer), sodium starch glycolate (cross-linked starch).

The water-soluble substrate-forming composition and the water-soluble substrate 10 formed therefrom can also comprise one or more additive or adjunct ingredients. For example, the water-soluble substrate-forming composition and the water-soluble substrate 10 may contain: plasticizers, lubricants, release agents, fillers, extenders, anti-blocking agents, de-tackifying agents, antifoams, or other functional ingredients. The latter may, in the case of articles containing compositions for washing, include, but are not limited to functional detergent additives to be delivered to the wash water, for example organic polymeric dispersants, or other detergent additives.

Suitable plasticizers include, but are not limited to: glycerol, glycerin, diglycerin, hydroxypropyl glycerine, sorbitol, ethylene glycol, diethylene glycol, triethylene glycol, tetraethylene glycol, propylene glycol, polyethylene glycols, neopentyl glycol, trimethylolpropane, polyether polyols, ethanolamines, and mixtures thereof. The plasticizer can be incorporated in the water-soluble substrate 10 in any suitable amount including amounts in the range of from about 5% to about 30% by weight, or in the range of from about 12% to about 20% by weight.

Suitable surfactants may include the nonionic, cationic, anionic and zwitterionic classes. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). The surfactant can be incorporated in the water-soluble substrate 10 in any suitable amount including amounts in the range of from about 0.01% to about 1% by weight, or in the range of from about 0.1% to about 0.6% by weight.

Suitable lubricants/release agents include, but are not limited to, fatty acids and their salts, fatty alcohols, fatty esters, fatty amines, fatty amine acetates and fatty amides. The lubricant/release agent can be incorporated in the water-soluble substrate 10 in any suitable amount including amounts within the range of from about 0.02% to about 1.5% by weight, or in the range of from about 0.04% to about 0.15% by weight.

Suitable fillers, extenders, antiblocking agents, detackifying agents include, but are not limited to: starches, modified starches, crosslinked polyvinylpyrrolidone, crosslinked cellulose, microcrystalline cellulose, silica, metallic oxides, calcium carbonate, talc and mica. The filler, extender, antiblocking agent, detackifying agent can be present in the water-soluble substrate 10 in any suitable amount including amounts in the range of from about 0.1% to about 25% by weight, or in the range of from about 1% to about 15% by weight. In the absence of starch, it may be desirable for the filler, extender, antiblocking agent, detackifying agent to be present in a range of from about 1% to about 5% by weight.

Suitable antifoams include, but are not limited to, those based on polydimethylsiloxanes and hydrocarbon blends. The antifoam can be present in the water-soluble substrate 10 in any suitable amount including amounts in the range of from about 0.001% to about 0.5%, or in the range of from about 0.01% to about 0.1% by weight.

The composition is prepared by mixing the materials and agitating the mixture while raising the temperature from about 70° F. (about 21° C.) to 195° F. (about 90° C.) until solution is complete. The substrate-forming composition may be made into any suitable form (e.g. film or sheets) and may then be subsequently formed into any suitable product (e.g. single- and multiple-compartment pouches, sachets, bags, etc.).

### Methods of Making a Water-Soluble Substrate

There are numerous non-limiting embodiments of the method of making the water-soluble substrate 10 described herein.

In one embodiment, the method comprises providing a previously formed water-soluble substrate 10 and applying glass beads 20 to at least one of the surfaces 12, 14 of the previously formed water-soluble substrate 10.

The glass beads 20 can be applied to the previously formed water-soluble substrate 10 in a number of different manners. In one non-limiting embodiment, the less water-soluble material 20 is applied to at least one of the surfaces 12, 14 of the previously formed water-soluble substrate 10 via a jet, or electrostatically. Due to the high speed of the jet, some of the glass beads 20 are embedded into the substrate, thereby reducing, or even eliminating the need for using a binder. Also when the glass beads 20 are electro-statically applied, a binder is generally not needed. Nevertheless, a binder may be used. The binder may first be applied to the water-soluble substrate 10, before the glass beads 20 are applied. Or, alternatively, the binder may be mixed with the glass beads 20, and then the mixture is added to the water-soluble substrate 10.

In another non-limiting embodiment of the method, the glass beads 20 are provided in the form of a liquid dispersion that is applied onto at least one of the surfaces 12, 14 of the water-soluble substrate 10, and is allowed to dry, or undergoes a drying process. The dispersion can be applied on the film by means of any coating process, including spray, knife, rod, kiss, slot, painting, printing and mixtures thereof. Printing is preferred for use herein. Printing is a well established and economic process. Printing is usually done with inks and coatings and used to impart patterns and colours to substrates but in the case of the invention printing is used to deposit the glass beads 20 onto a water-soluble substrate 10. Any kind of printing can be used, including rotogravure, lithography, flexography, porous and screen printing, inkjet printing, letterpress, tampography and combinations thereof.

These embodiments may also comprise a step of wetting at least a portion of at least one of the surfaces 12, 14 of the water-soluble substrate 10 prior to applying the glass beads 20 to the previously formed water-soluble substrate 10. The wetting of at least one of the surfaces 12, 14 of the water-soluble substrate 10 may be used to at least partially dissolve or solubilize an outer portion of the surface 12, 14 of the substrate 10 (that is, part of the way into the thickness of the substrate). The water-soluble substrate 10 may be at least partially solubilized to any suitable depth in order to partially embed the coating into the substrate. Suitable depths include, but are not limited to: from about 1% to about 40% or about 45%, from about 1% to about 30%, from about 1% to about 20%, from about 1% to about 15%, and alternatively, from about 1% to about 10% of the overall substrate thickness 16. The glass beads 20 are then applied to the partially dissolved portion of at least one of the surfaces 12, 14 of the substrate 10. This allows the glass beads 20 to be embedded into an outer portion of the surface 12, 14 of the substrate 10, and to become a more permanent part of the substrate 10. The wetted surface 12, 14 of the substrate 10 with the glass beads 20 embedded into the same is then permitted to dry. Such an embodiment of the method may also comprise a step of removing at least some of any loose or excess of glass beads 20 remaining on the surface of the water-soluble substrate 10 after it has dried, such as by wiping or dusting the surface of the substrate 10.

In another embodiment, the glass beads 20 can be added to the water-soluble substrate 10 after the substrate 10 is made into a product. For example, if the water-soluble substrate 10 is used to form a water-soluble pouch that contains a composition, the glass beads 20 can be added to the substrate 10 on at least a portion of the surface of the water-soluble pouch.

### Methods of Making a Water-Soluble Pouch

The water-soluble substrate 10 described herein can be formed into articles, including but not limited to those in which the water-soluble substrate 10 is used as a packaging material. Such articles include, but are not limited to water-soluble pouches, sachets, and other containers.

Water-soluble pouches and other such containers that incorporate the water-soluble substrate 10 described herein can be made in any suitable manner known in the art. The water-soluble substrate 10 can be provided with improved resistance to solubility either before or after forming the same into the final product. In either case, in certain embodiments it is desirable when making such articles, that the surface 12 of the substrate 10 on which the glass beads 20 are distributed, forms an outer surface of the article.

There are a number of processes for making water-soluble pouches. These include, but are not limited to processes known in the art as: vertical form-fill-sealing processes, horizontal form-fill sealing processes, and formation of the pouches in molds on the surface of a circular drum. In vertical form-fill-sealing processes, a vertical tube is formed by folding a substrate. The bottom end of the tube is sealed to form an open pouch. This pouch is partially filled allowing a head space. The top part of the open pouch is then subsequently sealed together to close the pouch, and to form the next open pouch. The first pouch is subsequently cut and the process is repeated. The pouches formed in such a way usually have pillow shape. Horizontal form-fill sealing processes use a die having a series of molds therein. In horizontal form-fill sealing processes, a substrate is placed in the die and open pouches are formed in these molds, which can then be filled, covered with another layer of substrate, and sealed. In the third process (formation of pouches in molds on the surface of a circular drum), a substrate is circulated over the drum and pockets are formed, which pass under a filling machine to fill the open pockets. The filling and sealing takes place at the highest point (top) of the circle described by the drum, e.g. typically, filling is done just before the rotating drum starts the downwards circular motion, and sealing just after the drum starts its downwards motion.

In any of the processes that involve a step of forming of open pouches, the substrate can initially be molded or formed into the shape of an open pouch using thermoforming, vacuum-forming, or both. Thermoforming involves heating the molds and/or the substrate by applying heat in any known way such as contacting the molds with a heating element, or by blowing hot air or using heating lamps to heat the molds and/or the substrate. In the case of vacuum-forming, vacuum assistance is employed to help drive the substrate into the mold. In other embodiments, the two techniques can be combined to form pouches, for example, the substrate can be formed into open pouches by vacuum-forming, and heat can be provided to facilitate the process. The open pouches are then filled with the composition to be contained therein.

The filled, open pouches are then closed, which can be done by any method. In some cases, such as in horizontal pouch-forming processes, the closing is done by continuously feeding a second material or substrate, such as a water-soluble substrate, over and onto the web of open pouches and then sealing the first substrate and second substrate together. The second material or substrate can comprise the water-soluble substrate 10 described herein. It may be desirable for the surface of the second substrate onto which the glass beads are applied, to be oriented so that it forms an outer surface of the pouch.

In such a process, the first and second substrates are typically sealed in the area between the molds, and, thus, between the pouches that are being formed in adjacent molds. The sealing can be done by any method. Methods of sealing include heat sealing, solvent welding, and solvent or wet sealing. The sealed webs of pouches can then be cut by a cutting device, which cuts the pouches in the web from one another, into separate pouches. Processes of forming water-soluble pouches are further described in U.S. patent application Ser. No. 09/994,533, Publication No. US 2002/0169092 A1, published in the name of Catlin, et al.

### Articles of Manufacture

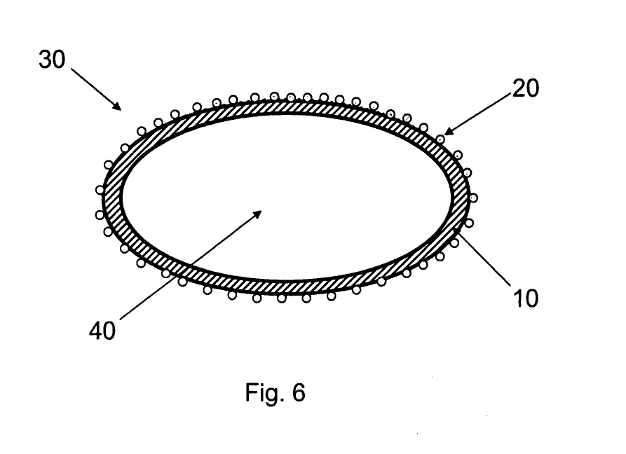

As shown in FIG. 6, the present invention may also include articles comprising a product composition 40 and a water-soluble substrate 10, which may be formed into a container 30, such as a pouch, a sachet, a capsule, a bag, etc. to hold the product composition. The surface of the water-soluble substrate 10 which has glass beads 20 applied thereto, may be used to form an outside surface of the container 30. The water-soluble substrate 10 may form at least a portion of a container 30 that provides a unit dose of the product composition 40.

For simplicity, the articles of interest herein will be described in terms of water-soluble pouches, although it should be understood that discussion herein also applies to other types of containers.

The pouches 30 formed by the foregoing methods, can be of any form and shape which is suitable to hold the composition 40 contained therein, until it is desired to release the composition 40 from the water-soluble pouch 30, such as by immersion of the water-soluble pouch 30 in water. The pouches 30 can comprise one compartment, or two or more compartments (that is, the pouches can be multi-compartment pouches). In one embodiment, the water-soluble pouch 30 may have two or more compartments that are in a generally superposed relationship and the pouch 30 comprises upper and lower generally opposing outer walls, skirt-like side walls, forming the sides of the pouch 30, and one or more internal partitioning walls, separating different compartments from one another. If the composition 40 contained in the pouches 30 comprises different forms or components, the different components of the composition 40 may be contained in different compartments of the water-soluble pouch 30 and may be separated from one another by a barrier of water-soluble material.

The pouches or other containers 30 may contain a unit dose of one or more compositions 40 for use as laundry detergent compositions, automatic dishwashing detergent compositions, hard surface cleaners, stain removers, fabric enhancers and/or fabric softeners, and new product forms where contact with small amounts of water could create premature pouch dissolution, unwanted pouch leakage and/or undesirable pouch-to-pouch stickiness. The composition 40 in the pouches 30 can be in any suitable form including, but not limited to: liquids, liquigels, gels, pastes, creams, solids, granules, powders, etc. The different compartments of multi-compartment pouches 30 may be used to separate incompatible ingredients. For example, it may be desirable to separate bleaches and enzymes into separate compartments. Other forms of multi-compartment embodiments may include a powder-containing compartment in combination with a liquid-containing compartment. Additional examples of multiple compartment water-soluble pouches are disclosed in U.S. Pat. No. 6,670,314 B2, Smith, et al.

### EXAMPLES

Glass 20-40 microns size clear micro-beads supplied by Jinan Huaming Microbead Co. Ltd (China), refractive index 1.93ND, are dispersed in water (15% beads, 85% water) and printed onto a standard 3 mil polyvinyl alcohol based water-soluble film supplied by Monosol.

To determine if a film is resistant to accidental water contact, a Droplet Test method on a non-stretched film has been developed. In this test, a film is placed under low tension in a 10 mm knitting hoop. 0.2 ml of 23° C. water is placed in the center of the film using a 1 ml syringe. A stopwatch is started as soon as the water contacts the film and the time when significant film deformation is observed is recorded. This time, termed “Time to Deform” is a precursor to film failure.

### Results

| Material | Time to Deform |
|---|---|
| Uncoated M8630 film | 15 seconds |
| M8630 coated with micro- | 30 seconds |
| beads | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble substrate comprising a first surface and a second surface opposite to said first surface, and a thickness between said first and second surfaces, glass beads applied to at least one of said first and second surfaces, said glass beads having an average diameter of from about 1 micrometer to about 5000 micrometers.

2. A water-soluble substrate according to claim 1, wherein said glass beads have an average diameter of from about 1 micrometer to about 100 micrometers.

3. A water-soluble substrate according to claim 1, wherein said glass beads cover from about 5% to about 100% of the surface of said water-soluble substrate.

4. A water-soluble substrate according to claim 1, wherein said glass beads are hollow.

5. A water-soluble substrate according to claim 4, wherein said glass beads comprise at least one benefit agent.

6. A water-soluble substrate according to claim 1, wherein said glass beads are colored.

7. A water-soluble substrate according to claim 1, wherein said glass beads are at least partially coated with silicone.

8. A water-soluble substrate according to claim 1, wherein said glass beads are at least partially coated with a material that reflects or diffracts light.

9. A water-soluble substrate according to claim 1, wherein said glass beads create a visual effect on said at least one of said first and second surfaces.

10. An article comprising the water-soluble substrate according to claim 1, wherein said glass beads forms an outside surface of said article.

11. An article according to claim 10 wherein said article forms at least a portion of a container which comprises a product composition.

12. A method of producing a water-soluble substrate according to claim 1, comprising the step of applying glass beads to at least one of said first and second surfaces.

13. A method according to claim 12, wherein said applying step comprises applying glass beads to said water-soluble substrate via a jet or electrostatically.

14. A method according to claim 12 wherein the applying step comprises applying a dispersion of glass beads to said water-soluble substrate via spray, knife, rod, kiss,
